(19) United States
(12) Patent Application Publication
(10) Pub. No.: US 2023/0294560 A1
(43) Pub. Date: Sep. 21, 2023

(54) STRAY CURRENT MITIGATION ASSEMBLIES HAVING A CARBON CONDUCTION SUBASSEMBLY

(71) Applicants: Alfred B. Craig, Upper Marlboro, MD (US); Yunxiang Chen, Bethesda, MD (US)

(72) Inventors: Alfred B. Craig, Upper Marlboro, MD (US); Yunxiang Chen, Bethesda, MD (US)

(21) Appl. No.: 17/698,543

(22) Filed: Mar. 18, 2022

(51) Int. Cl. B60M 5/02

(52) U.S. Cl. CPC B60M 5/02

(57) ABSTRACT

A stray current mitigation assembly includes a carbon conduction subassembly configured to be embedded in a subsurface adjacent an electrically conductive structure. The carbon conduction subassembly includes a carbon fiber fabric layer and one or more conductive extensions electrically coupled to the carbon fiber fabric layer. The carbon fiber fabric layer is configured to capture stray current generated by the electrically conductive structure and the one or more conductive extensions are configured to carry captured stray current along a length of the one or more conductive extensions.

### TECHNICAL FIELD

Disclosed herein are methods and systems for mitigating stray current for electrically conductive structures, such as electrified rail systems.

### BACKGROUND

In many electrified rail transit systems, running rails carry return current back to power substations. Due to soil conditions and the resistance between the running rails and the ground, a small amount of current (i.e., stray current) flows from the running rails into the ground. Stray current does not flow to the power substation along the running rails, but instead travels through other conductive paths, such as water pipes, gas pipes, and other conductive subterranean structures, particularly those having steel structures. Stray current causes corrosion damage to the conductive paths it follows, and can compromise safety.

A current technique for mitigating stray current includes installing insulation materials between the running rails and the ground. The insulating materials limit the magnitude of stray current. However, insulating materials nonetheless permit some stray current flow, and the insulating materials deteriorate over time, increasing the amount of stray current that enters the ground.

There is a need in the industry for improved methods and systems for mitigating stray current.

### SUMMARY

In one embodiment, a stray current mitigation assembly includes a carbon conduction subassembly configured to be embedded in a subsurface adjacent an electrically conductive structure. The carbon conduction subassembly includes a carbon fiber fabric layer and one or more conductive extensions electrically coupled to the carbon fiber fabric layer. The carbon fiber fabric layer is configured to capture stray current generated by the electrically conductive structure and the one or more conductive extensions are configured to carry captured stray current along a length of the one or more conductive extensions.

In another embodiment, a method of carrying stray current includes capturing stray current flowing from an electrically conductive structure with a carbon fiber fabric layer of a conductive carbon subassembly of a stray current mitigation assembly. The conductive carbon subassembly (or carbon conduction subassembly) further includes one or more conductive extensions electrically coupled to the carbon fiber fabric layer. The carbon conduction subassembly is embedded in a subsurface adjacent (e.g., under) the electrically conductive structure. The method also includes carrying stray current along the one or more conductive extensions of the carbon conduction subassembly to a power management station electrically coupled to the one or more conductive extensions.

In yet another embodiment, a stray current mitigation assembly includes a carbon conduction subassembly configured to be embedded in a subsurface adjacent (e.g., under) an electrically conductive structure. The carbon conduction subassembly includes a carbon fiber fabric layer and one or more conductive extensions. The one or more conductive extensions include at least one metal mesh layer in contact with the carbon fiber fabric layer. The carbon fiber fabric layer is configured to capture stray current generated by the electrically conductive structure. In addition, the at least one metal mesh layer is electrically coupled to a power source such that the at least one metal mesh layer carries captured stray current from the carbon fiber fabric layer to the power source. The stray current mitigation assembly further includes an insulation layer configured to be embedded in the subsurface below the carbon fiber fabric layer such that the carbon fiber fabric layer is disposed between the insulation layer and the at least one metal mesh layer.

These and additional features of embodiments described herein are more fully described and illustrated herein, and in the accompanying drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the drawings, where like structure is indicated with like reference numerals and in which:

FIG. 1 schematically depicts an exemplary electrified system including a power source electrically coupled to a stray current mitigation assembly disposed in a subsurface below an electrically conductive structure comprising a rail bed, according to one or more embodiments shown and described herein;

FIG. 2 schematically depicts a cross section of an exemplary electrified system including a stray current mitigation assembly with conductive extensions coupled to a carbon fiber fabric layer disposed in a subsurface below a rail bed, according to one or more embodiments shown and described herein;

FIG. 3 schematically depicts a cross section of an exemplary electrified system including a stray current mitigation assembly with conductive extensions contacting a carbon fiber fabric layer disposed in a subsurface below a pipeline, according to one or more embodiments shown and described herein;

FIG. 4 schematically depicts a detailed view of a stray current mitigation assembly with conductive extensions coupled to a carbon fiber fabric layer, according to one or more embodiments shown and described herein;

FIG. 5 schematically depicts a cross section of an exemplary electrified system including a stray current mitigation assembly with conductive extensions comprising a metal mesh contacting a carbon fiber fabric layer, the stray current mitigation assembly disposed in a subsurface below a rail bed, according to one or more embodiments shown and described herein; and

FIG. 6 schematically depicts a cross section of an exemplary electrified system including a stray current mitigation assembly with conductive extensions positioned between and contacting two carbon fiber fabric layers disposed in a subsurface below a pipeline, according to one or more embodiments shown and described herein.

### DETAILED DESCRIPTION

Embodiments described herein include those directed to a stray current mitigation assembly comprising a carbon conduction subassembly that includes at least one carbon fiber fabric layer and one or more conductive extensions electrically coupled to a layer of at least one carbon fiber fabric (also referred to herein as “the at least one carbon fiber fabric layer”). The one or more conductive extensions comprise a conductive material that may be physically coupled to the carbon fiber fabric layer or disposed adjacent and in contact with the carbon fiber fabric layer. The one or more conductive extensions are positioned along the length of the carbon fiber fabric layer and provide an electrical pathway for stray current captured by the carbon fiber fabric layer. In operation, the material of the carbon fiber fabric may capture stray current and the one or more conductive extensions may carry the stray current to a power source, such as a traction power substation, or to the conductive structure from which the stray current leaks, along which it eventually returns to a power source. By carrying stray current back to a power source, the conductive extensions prevent or substantially diminish stray current from leaking out along other unintended paths. Various embodiments of the stray current mitigation system, and the operation of the stray current mitigation system, are described in more detail herein. As appropriate, reference numerals will be used consistently throughout the drawings to refer to the same or like parts.

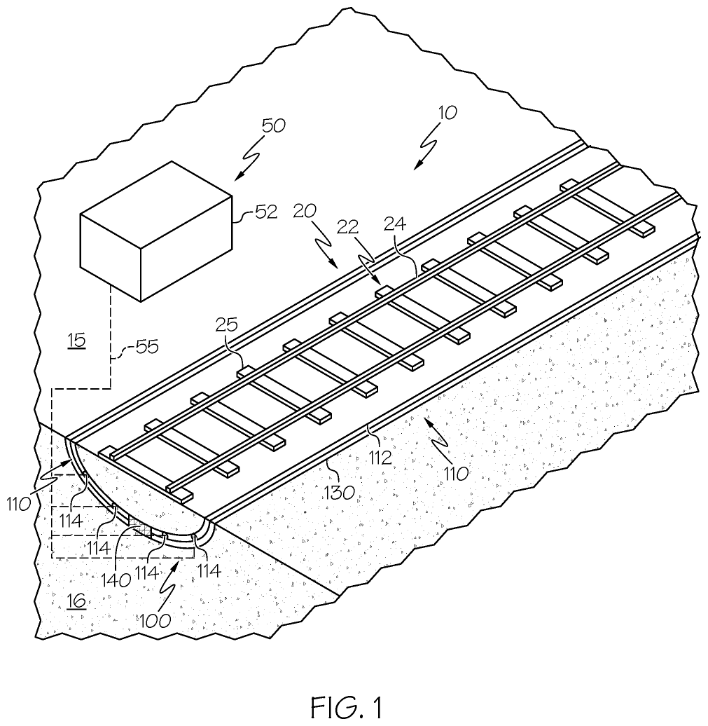

Referring now to FIGS. 1-6, embodiments of an electrified system 10 are schematically shown. The electrified system 10 includes a stray current mitigation assembly 100 embedded in a subsurface 16 that is adjacent (e.g., under) an electrically conductive structure 20. The stray current mitigation assembly 100 comprises a carbon conduction subassembly 110 that includes a carbon fiber fabric layer 112 and one or more conductive extensions 114 electrically coupled to the carbon fiber fabric layer 112. The stray current mitigation assembly 100 further comprises an insulation layer 130 disposed adjacent (e.g., under) the carbon conduction subassembly 110. The carbon conduction subassembly 110 is readily installed adjacent (e.g., under) the electrically conductive structure 20, and provides stray current protection. In operation, the electrically conductive structure 20 generates stray current that travels from the electrically conductive structure 20 into the subsurface 16. As used herein, “stray current” refers to current flowing through paths other than the intended electrical circuit. By capturing stray current using the stray current mitigation assembly 100 described herein, corrosion of surrounding equipment is reduced, and unintended current flow within the subsurface 16 can also be reduced.

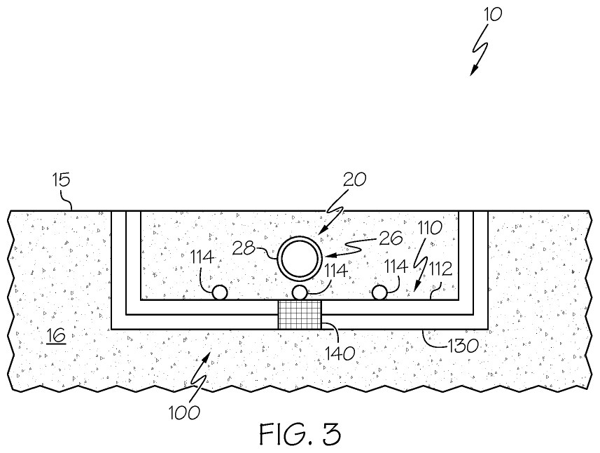

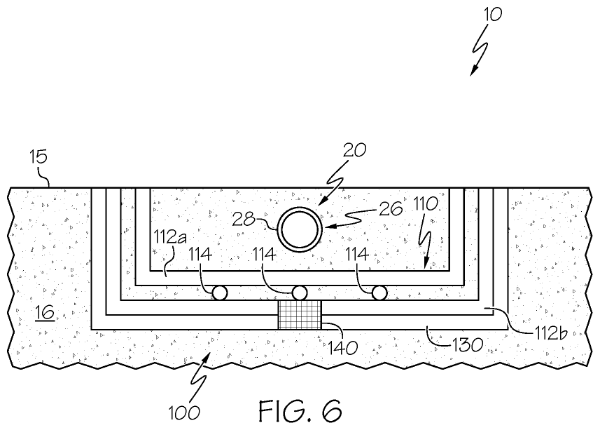

In some embodiments, the electrically conductive structure 20 comprises an external electrically conductive structure 22, such as a railway 24 (FIGS. 1, 2, and 5), that is positioned along a ground surface 15. As shown in FIGS. 1, 2, and 5, the railway may be supported by a plurality of ties 25, which may comprise wooden ties, concrete ties, or another non-electrically conductive material. In embodiments in which the electrified system 10 comprises a railway 24, the carbon conduction subassembly 110 removes the need for insulation layers between the railway 24 and the ground surface 15. Moreover, both the insulation layer 130 and the carbon fiber fabric layer 112 have a longer life span than current insulation layers used between the railway 24 and the ground surface 15 because insulation layers disposed on the ground surface 15 are exposed to sunlight, rain, snow, and other compromising conditions. In other embodiments, the electrically conductive structure 20 comprises an embedded electrically conductive structure 26, such as a pipeline 28 (FIGS. 3 and 6) or an underground facility, that is positioned within the subsurface 16. The embodiments described herein may further include electrically conductive structures 20 that partially extend into the subsurface 16.

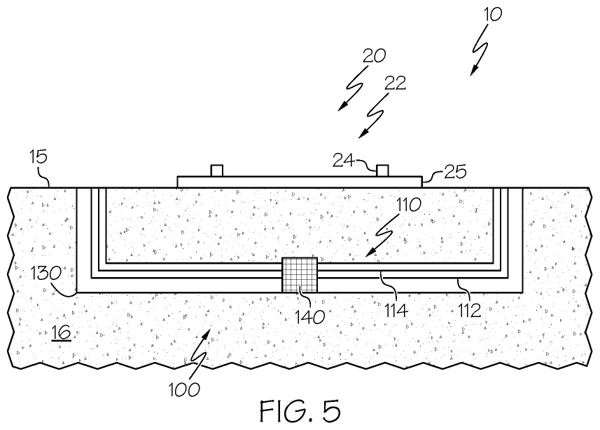

The one or more conductive extensions 114 may comprise a conductive metal, such as copper, silver, gold, zinc, nickel, platinum, conductive alloys, and the like. The one or more conductive extensions 114 may extend along the length of the carbon conduction subassembly 110, electrically coupled to the carbon fiber fabric layer 112. In some embodiments, the conductive extensions 114 comprise metal wires extending along the length of the carbon conduction subassembly 110. Exemplary conductive wires include copper wires, aluminum wires, or other metal wires. An example copper wire includes 18/1 copper stranded wire. In other embodiments, the conductive extensions 114 may comprise a metal mesh, such as a copper mesh or an aluminum mesh, as shown in FIG. 5. Furthermore, it is contemplated that the carbon conduction subassembly 110 may include conductive extensions 114 that comprise one or more metal mesh layers in combination with one or more metal wires.

As shown in FIG. 1, the one or more conductive extensions 114 of the carbon conduction subassembly 110 may be electrically coupled to a power source 50, such as a traction power substation 52. In some embodiments, the one or more conductive extensions 114 are directly connected to the power source 50, in another embodiment, electrical pathways 55 connect the one or more conductive extensions 114 and the power source 50; and in other embodiments, the one or more conductive extensions 114 are electrically connected back to the railway 24 or pipe 28, i.e., where the stray current is lower or is otherwise limited or easily managed. In operation, the carbon fiber fabric layer 112 of the carbon conduction subassembly 110 may capture stray current flowing from the electrically conductive structure 20. Further, the conductive extensions 114 of carbon conduction subassembly 110 carry stray current along a length of the conductive extensions 114, for example, to the power source 50 (such as the traction power substation 52), preventing the stray current from leaking out along other unintended paths.

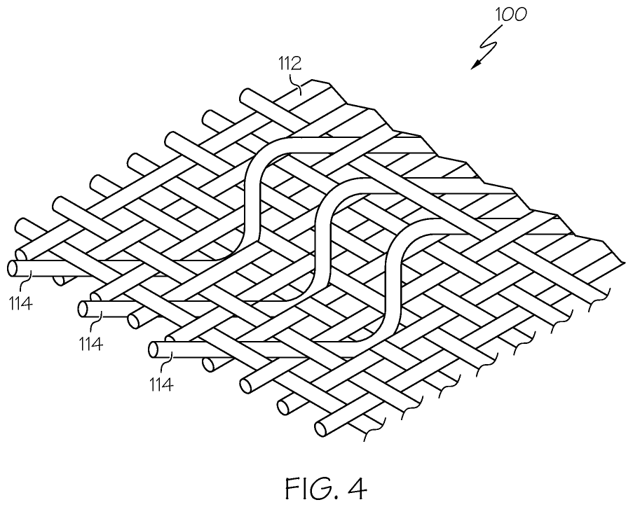

As shown in FIGS. 1-6, the one or more conductive extensions 114 are in physical contact with the carbon fiber fabric layer 112. In some embodiments, the conductive extensions 114 may be physically coupled to the carbon fiber fabric layer 112 using fasteners, adhesives, or a combination thereof. In some embodiments, as depicted in FIG. 4, the one or more conductive extensions 114 is physically coupled to the carbon fiber fabric layer 122 by weaving or otherwise embedding the conductive extensions 114 into the carbon fiber fabric layer 112. For example, the one or more conductive extensions 114 may include thin metal wires, such as aluminum or copper wires, woven into the fabric of the carbon fiber fabric layer 112. In other embodiments, the conductive extensions 114 may be in contact with the carbon fiber fabric layer 112 without physically coupling the conductive extensions 114 to the carbon fiber fabric layer 112. For example, as shown in FIGS. 3 and 5, the one or more conductive extensions 114 may lie on the carbon fiber fabric layer 112, such that the conductive extensions 114 are between the electrically conductive structure and at least a portion of the carbon fiber fabric layer 112. Furthermore, the carbon conduction subassembly 110 may include both metal wires woven into the carbon fiber fabric layer 112 and one or more metal mesh layers disposed on the carbon fiber fabric layer 112.

Referring to FIG. 6, in some embodiments, the carbon conduction subassembly 110 comprises a first carbon fiber fabric layer 112a and a second carbon fiber fabric layer 112b and the one or more conductive extensions 114 may be positioned between and in contact with the first carbon fiber fabric layer 112a and the second carbon fiber fabric layer 112b. While two carbon fiber fabric layers 112a, 112b are depicted in FIG. 6, embodiments comprising more than two carbon fiber fabric layers 112 disposed in a stacked orientation are contemplated. Furthermore, embodiments of the carbon conduction subassembly 110 may have multiple carbon fiber fabric layers 112 disposed along the length of the carbon conduction subassembly 110, that is, adjacently disposed (e.g., physically coupled together or in contact) in a direction parallel the ground surface 15 to form the full length of the carbon conduction subassembly 110, for example, when a carbon conduction subassembly 110 is desired over a distance that is longer than the length of commercially produced carbon fiber fabric layers 112. Indeed, when the electrically conductive structure 20 extends over a long distance (e.g., 100 yards or longer), installation efficiency may be increased by using multiple carbon fiber fabric layers 112 to form the carbon conduction subassembly 110 over the long distance.

Referring again to FIGS. 1-6, the stray current mitigation assembly 100 may further comprise an insulation layer 130 and one or more grate structures 140. The insulation layer 130 may comprise a rubber material or other impermeable and electrical insulating material. The insulation layer 130 is positioned below the carbon conduction subassembly 110. In operation, the insulation layer 130 provides both a fluidic and electrical barrier to prevent stray current from leaking into the surrounding earth (i.e., the subsurface 16) and from leaking to additional conductive structures positioned near the stray current mitigation assembly 100 and the electrically conductive structure 20. The one or more grate structures 140 comprise a non-conductive material, such as a plastic or polymer material and provide a fluid pathway for water to travel away from the carbon conduction subassembly 110 and the insulation layer 130. This prevents water from being trapped on the carbon conduction subassembly 110 and/or the insulation layer 130, minimizing water damage to the carbon conduction subassembly 110 and the insulation layer 130. The one or more grate structures 140 are positioned to allow fluid flow along the one or more grate structures 140, improving drainage away from both the stray current mitigation assembly 100 and the electrically conductive structure 20. For example, the one or more grate structures 140 may be intermittently disposed along the length of the carbon conduction subassembly 110, for example, every 50 feet to 150 feet, such as every 100 feet. Moreover, the one or more grate structures 140 may extend through holes in the insulation layer 130, the carbon fiber fabric layer(s) 112, and the metal mesh layer, when the conductive extensions 114 comprise a metal mesh layer.

Referring again to FIGS. 1-6, the stray current mitigation assembly 100 is disposed in the subsurface 16, below the electrically conductive structure 20, and may extend upward to the ground surface 15 at locations laterally offset from the electrically conductive structure 20. In particular, the carbon fiber fabric layer 112, the insulation layer 130, and the metal mesh layer, when the conductive extensions 114 comprise a metal mesh layer, may each extend upward to the ground surface 15 at locations laterally offset from the electrically conductive structure 20. Thus, as shown in FIGS. 1-6, the stray current mitigation assembly 100 surrounds the portion of the subsurface 16 immediately adjacent the electrically conductive structure 20. Without intending to be limited by theory, extending the stray current mitigation assembly 100 upward to the ground surface 15 may help capture stray current that flows from the electrically conductive structure 20 at an angle (i.e., an angle that is not straight down from the ground surface 15).

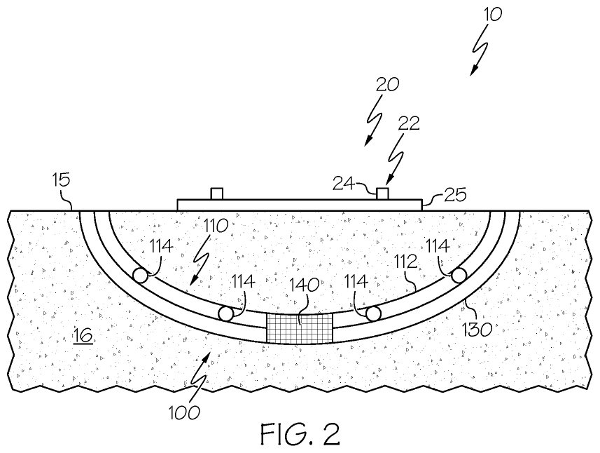

As shown in FIGS. 1 and 2, the stray current mitigation assembly 100 may be embedded in the subsurface 16 in a curved arrangement, for example, curved upward toward the ground surface 15. As shown in FIGS. 3, 5, and 6, the stray current mitigation assembly 100 may be embedded in the subsurface 16 in a rectilinear arrangement. In the rectilinear arrangement, the stray current mitigation assembly 100 is parallel to the ground surface 15 at locations in the subsurface 16 directly below the electrically conductive structure 20, and may be turned upward toward the ground surface 15 at locations laterally offset the electrically conductive structure 20, and extending linearly to the ground surface 15. The rectilinear arrangement facilitates efficient installation of the carbon conduction subassembly 110, as well as the one or more grate structures 140 and the insulation layer 130 in the subsurface 16.

Embodiments described herein are include a stray current mitigation assembly comprising a carbon conduction subassembly that includes at least one carbon fiber fabric layer for capturing stray current and one or more conductive extensions for carrying stray current captured by the carbon fiber fabric layer to a power source, e.g., a traction power substation to prevent stray current from leaking out along other unintended paths. The stray current mitigation assembly further comprises an insulation layer disposed below the carbon conduction subassembly to prevent stay current and water leaking to the surrounding earth. The stray current mitigation assembly provides an effective, easy to install system for mitigating stray current for a variety of electrically conductive structures, such as railways and pipelines.

Reference herein to a variable being a “function” of a parameter or another variable is not intended to denote that the variable is exclusively a function of the listed parameter or variable. Rather, referring to a variable that is a “function” of a listed parameter is open-ended such that the variable may be a function of a single parameter or a plurality of parameters.

Recitation herein of “at least one” component, element, etc., should not be used to create an inference that the alternative use of the articles “a” or “an” should be limited to a single component, element, etc.

Recitation herein of a component being “configured” in a particular way, to embody a particular property, or function in a particular manner, are structural recitations, as opposed to recitations of intended use. More specifically, reference herein to the manner in which a component is “configured” denotes an existing physical condition of the component and, as such, is to be taken as a definite recitation of the structural characteristics of the component.

Having described the subject matter of the present disclosure in detail and by reference to specific embodiments thereof, the various details disclosed herein should not be taken to suggest that these details relate to elements that are essential components of the various embodiments described herein, even in cases where a particular element is illustrated in each of the drawings that accompany the present description. Further, modifications and variations in structure and arrangement are possible without departing from the scope of the present disclosure, including, but not limited to, embodiments defined in the appended claims. More specifically, although some aspects of the present disclosure might be described as preferred or particularly advantageous, the present disclosure is not necessarily limited to such arrangements, features, or structure.

Where any of the following claims utilizes the term “wherein” as a transitional phrase, the term is an open-ended transitional phrase used to introduce a recitation of a series of characteristics of the structure, and should be interpreted in like manner as the more commonly used open-ended preamble term “comprising.

What is claimed is:

1. A stray current mitigation assembly comprising:
a carbon conduction subassembly configured to be embedded in a subsurface adjacent an electrically conductive structure, wherein:
the carbon conduction subassembly comprises a carbon fiber fabric layer and one or more conductive extensions electrically coupled to the carbon fiber fabric layer;
the carbon fiber fabric layer is configured to capture stray current generated by the electrically conductive structure; and
the one or more conductive extensions are configured to carry captured stray current along a length of the one or more conductive extensions.

2. The stray current mitigation assembly of claim 1, wherein the carbon fiber fabric layer comprises a first carbon fiber fabric layer and the carbon conduction subassembly further comprises a second carbon fiber fabric layer.

3. The stray current mitigation assembly of claim 2, wherein the one or more conductive extensions are positioned between the first carbon fiber fabric layer and the second carbon fiber fabric layer in contact with the first carbon fiber fabric layer and the second carbon fiber fabric layer.

4. The stray current mitigation assembly of claim 1, wherein the one or more conductive extensions contact the carbon fiber fabric layer.

5. The stray current mitigation assembly of claim 4, wherein the one or more conductive extensions are woven into the carbon fiber fabric layer.

6. The stray current mitigation assembly of claim 1, wherein the one or more conductive extensions comprise one or more metal wires.

7. The stray current mitigation assembly of claim 1, wherein the one or more conductive extensions comprise one or more metal mesh layers.

8. The stray current mitigation assembly of claim 1, wherein the one or more conductive extensions are electrically coupled to a power source.

9. The stray current mitigation assembly of claim 1, further comprising an insulation layer configured to be embedded in the subsurface below the carbon fiber fabric layer.

10. The stray current mitigation assembly of claim 9, further comprising a plurality of grate structures extending through the insulation layer and the carbon fiber fabric layer and intermittently positioned along a length of the carbon conduction subassembly.

11. A method of carrying stray current, the method comprising:
capturing stray current from an electrically conductive structure with a carbon fiber fabric layer of a carbon conduction subassembly of a stray current mitigation assembly, wherein:
the carbon conduction subassembly comprises one or more conductive extensions electrically coupled to the carbon fiber fabric layer; and
the carbon conduction subassembly is embedded in a subsurface adjacent the electrically conductive structure; and
carrying stray current along the one or more conductive extensions of the carbon conduction subassembly to a power source electrically coupled to the one or more conductive extensions.

12. The method of claim 11, further comprising an insulation layer embedded in the subsurface adjacent the carbon fiber fabric layer.

13. The method of claim 12, further comprising a plurality of grate structures extending through the insulation layer and the carbon fiber fabric layer and intermittently positioned along a length of the carbon conduction subassembly.

14. The method of claim 11, wherein the electrically conductive structure comprises an external electrically conductive structure.

15. The method of claim 11, wherein the electrically conductive structure comprises an embedded electrically conductive structure.

16. The method of claim 11, wherein the carbon fiber fabric layer comprises a first carbon fiber fabric layer and the carbon conduction subassembly further comprises a second carbon fiber fabric layer, and the one or more conductive extensions are positioned between the first carbon fiber fabric layer and the second carbon fiber fabric layer in contact with the first carbon fiber fabric layer and the second carbon fiber fabric layer.

17. The method of claim 11, wherein the one or more conductive extensions contact the carbon fiber fabric layer.

18. The method of claim 11, wherein the one or more conductive extensions comprise one or more metal wires, one or more metal mesh layers, or a combination thereof.

19. A stray current mitigation assembly comprising:
a carbon conduction subassembly configured to be embedded in a subsurface adjacent an electrically conductive structure, wherein:
the carbon conduction subassembly comprises a carbon fiber fabric layer and one or more conductive extensions;
the one or more conductive extensions comprise at least one metal mesh layer in contact with the carbon fiber fabric layer;
the carbon fiber fabric layer is configured to capture stray current generated by the electrically conductive structure; and
the at least one metal mesh layer is electrically coupled to a power source such that the at least one metal mesh layer carries captured stray current from the carbon fiber fabric layer to the power source; and
an insulation layer configured to be embedded in the subsurface adjacent the carbon fiber fabric layer such that the carbon fiber fabric layer is disposed between the insulation layer and the at least one metal mesh layer.

20. The stray current mitigation assembly of claim 19, further comprising a plurality of grate structures extending through the insulation layer, the carbon fiber fabric layer, and the at least one metal mesh layer and intermittently positioned along a length of the carbon conduction subassembly.

21. The stray current mitigation assembly of claim 1, wherein the one or more conductive extensions are electrically coupled to a power source via rail or other conductive structure.
